(19) United States
(12) Patent Application Publication
(10) Pub. No.: US 2025/0053926 A1
(43) Pub. Date: Feb. 13, 2025

(54) Segmenting Virtual Collaboration Environment Based on Participant Proficiency

(71) Applicant: International Business Machines Corporation, Armonk, NY (US)

(72) Inventors: Fang Lu, Billerica, MA (US); Jeremy R. Fox, Georgetown, TX (US); Tushar Agrawal, West Fargo, ND (US); Sarbajit K. Rakshit, Kolkata (IN)

(21) Appl. No.: 18/231,478

(22) Filed: Aug. 8, 2023

(51) Int. Cl. G06Q 10/10; G06F 9/455

(52) U.S. Cl. CPC G06Q 10/103; G06F 9/45558

(57) ABSTRACT

Mechanisms are provided for segmenting a virtual collaboration environment of a virtual collaboration based on participant proficiency with collaboration topics of the virtual collaboration. Interaction data is collected from a first participant of the virtual collaboration environment, which corresponds to at least one of communications exchanged, actions performed, or reactions. The first participant is classified in a level of participant proficiency with collaboration topics of the virtual collaboration environment based on the interaction data. The virtual collaboration environment is segmented into a plurality of collaboration sub-groups and participants are assigned to the collaboration sub-groups based on determined levels of participant proficiency. Content provided to the participants and communication channels between the participants are aligned based on the assignment of participants to collaboration sub-groups in the plurality of collaboration sub-groups.

### BACKGROUND

The present application relates generally to an improved data processing apparatus and method and more specifically to an improved computing tool and improved computing tool operations/functionality for segmenting a virtual collaboration environment based on participant proficiency.

Virtual environments provided through distributed and wide area computer networks are fast becoming a tool through which users may collaborate for both work and pleasure. For example, various social groups may be established through social networking websites and virtual environments, similar to clubs and associations in the real world, where the virtual environment provides an infrastructure through which the users may interact with one another using virtual avatars and the like. Similarly, work groups, work meetings, and the like may be established via such virtual environments to allow users to collaborate with one another on projects and tasks. The users may be physically located near or remote to each other, as distances have little meaning within computer networks, allowing users from various geographic locations to collaborate with one another as if they are local to one another, such as in the same virtual room or other virtual environment.

Recently, advances in computer technology have been made that permit the combining of virtual environments into even greater virtual spaces, such as the Metaverse, which may also be referred to as “virtual worlds”. The Metaverse is a network of three dimensional virtual environments focused on social connection. In futurism and science fiction, it is often described as a hypothetical iteration of the Internet as a single, universal virtual world that is facilitated by the use of virtual reality (VR) and augmented reality (AR) equipment to allow users to engage in an immerse themselves in virtual environments for work and/or entertainment purposes. People across the world can collaborate with each other, view, and virtually interact with each other's avatars in the Metaverse collaboration environments. The interactions may be of similar natures to the way that human beings interact in the real world, but via virtual mechanisms and virtual environment constructs. Such interactions between users may include various work and entertainment interactions such as gaming interactions, work meetings, shopping for virtual objects and/or physical objects (bridging the virtual and physical worlds), exploring virtual environments, and the like.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for segmenting a virtual collaboration environment of a virtual collaboration based on participant proficiency with collaboration topics of the virtual collaboration. The method comprises collecting, from a first participant of the virtual collaboration environment, interaction data corresponding to at least one of communications exchanged by the first participant with one or more second participants in the virtual collaboration environment, actions performed by the first participant or an avatar of the first participant, or reactions performed by the first participant or avatar in response to interactions by the one or more second participants. The method also comprises classifying the first participant with regard to a level of participant proficiency with collaboration topics of the virtual collaboration environment based on the interaction data. In addition, the method comprises segmenting the virtual collaboration environment into a plurality of collaboration sub-groups and assigning participants to the plurality of collaboration sub-groups based on determined levels of participant proficiency of the first participant and the one or more second participants. Furthermore, the method comprises aligning content provided to the participants of the virtual collaboration and communication channels between the participants of the virtual collaboration based on the assignment of participants to collaboration sub-groups in the plurality of collaboration sub-groups.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram of the primary operational components of a dynamic virtual collaboration environment segmentation engine in accordance with one illustrative embodiment;

FIG. 3 is an example diagram illustrating the dynamic segmentation of a virtual collaboration environment in accordance with one illustrative embodiment; and

FIG. 4 is a flowchart outlining an example operation for dynamically segmenting a virtual collaboration environment in accordance with one illustrative embodiment.

### DETAILED DESCRIPTION

As noted above, virtual environments, through which users may interact with one another via computing devices, using virtual and/or augmented reality equipment, are being proliferated in the current information technology and computer oriented society. These mechanisms facilitate interactions between users for work and personal entertainment purposes. Such interactions mimic the interactions between users in physical (real) world scenarios, such as work meetings, getting together to have discussions, engage in entertainment activities such as playing games with each other, social interactions, and the like. As such, the collaborations between users may be of various types. However, current mechanisms place the burden on the user to adapt to the virtual environment when engaging in these collaborations, i.e., the virtual environment is provided as is and the user may make use of the virtual environment, but currently there is no ability to automatically modify the virtual environment to the particular type of collaboration that the users are engaged in. Thus, there is a need to have different types of collaborative environments, and mechanisms for automatically identifying the type of collaboration environment to provide for a particular type of collaboration, so that appropriate virtual representations and ambiance for the specific types of collaboration can be created. This is especially true when the scale of the virtual space expands, as in the case of the Metaverse, which may cross various geographical and cultural borders of the physical or real world with regard to the users that make use of the virtual space.

In a virtual collaboration environment, such as in a Metaverse environment, multiple users can come together and interact with each other, like attending meetings, presentations, or attend learning sessions, where the different participants in these collaborations will have a different level of understanding of discussion content, such as learning content, project or task content for work groups, or the like, so that if a metaverse participant, i.e., a first participant, asks a question, or wants to obtain additional information, or demonstrates a lower level of understanding of subject matter being discussed, then other participants will be disturbed because the other participants may not want such detail for various reasons or may not be as patient while waiting for the first participant's understanding to be elevated. For example, other participants may have a background knowledge or understanding that the first participant does not have, e.g., greater knowledge of the subject of the collaboration than the first participant requesting the additional information, a different level of interest than the first participant, or the like, such that these other participants become disturbed while the first participant's difference in knowledge, experience, understanding, or interest is addressed. Thus, there is a need for specific improved computing tools and improved computing tool operations/functionality in virtual environments and/or virtual worlds (a combination of virtual environments) to dynamically segment collaboration groups based on user interaction patterns of the collaborating participants.

In a collaborative virtual environment, the illustrative embodiments provide improved computing tools and improved computing tool operations/functionality to track the number of participants (users) who have joined a collaboration and to evaluate the progress of the collaboration through analysis of patterns of interactions and discourse between users, e.g., questions posed by users to one another as part of the collaboration, to thereby evaluate the level of proficiency of each of the users with regard to the subject matter topic(s) of the collaboration. These patterns of interaction and discourse may include the participants' (users') reactions to changes in the collaborative virtual environment. These patterns may include, for example, other users' input to the collaborative virtual environment, and changes in the collaborative virtual environment based on such user inputs, as well as reactions to specific statements, questions, and the like, made by other participants in the collaboration. The evaluation of such patterns of interaction, discourse, and the like, may involve performing speech-to-text translation when the inputs are speech input, and may include natural language processing of textual representations of user inputs to identify various characteristics of the user inputs.

In some illustrative embodiments, the identification of these patterns of interactions and discourse may include evaluating question types of questions being asked by the various participants in the collaboration, the time required for answering the question, and the particular types of answers provided by various ones of the participants. The identification of these patterns may further include identifying which, if any, participants elect to not respond to a question posed by another participant. In some illustrative embodiments, the behavior, communication inputs, actions of the virtual avatar, and communication responses of participants within the virtual environment may be analyzed to identify these patterns, and such patterns may be further evaluated with regard to established user profile information. For example, a user profile may be established that specifies the cultural background of the participant, which may be used to gain further understanding of the user's behavior, communication inputs, actions of their avatar, and communication responses to account for cultural differences between participants. In addition, in some illustrative embodiments, unique user requirements may also be specified in the user profile, such as visual impairment, hearing impairment or other special needs, and considered as an additional factor in classifying participants for collaboration sub-group classification as discussed hereafter.

The various factors are extracted from the virtual environment related data and evaluated by a plurality of trained machine learning computer models based on the types of factors, e.g., machine learning models including natural language processing, sentiment analysis, image analysis, and other pattern analysis and rules based engines, to extract the various features that are then input to a collaboration group participant classification computer model that is trained and configured to classify individual participants of a collaboration group into a plurality of predefined participant classification groups. The participant classification groups may include, for example, different participant classification groups for different predefined levels of understanding, comfort, or experience with a topic of the collaboration group, which is also collectively referred to as participant “proficiency” herein.

Based on the classification of the participants into different participant classifications, the participants may be assigned to different collaboration sub-groups, e.g., a first collaboration sub-group associated with participants that have demonstrated through the evaluated factors that they have a basic level of the topics and concepts involved in the collaboration, a second collaboration sub-group associated with participants that have demonstrated an intermediate level of understanding, experience, and comfort (participant proficiency) with the topics and concepts based on the evaluated factors, and a third collaboration sub-group associated with participants that have demonstrated an advanced level of participant proficiency with the topics and concepts based on the evaluated factors. Based on the evaluation of the various factors and the classification of the participants based on the evaluation of these factors, the participants may be tagged, labeled, or otherwise associated with metadata specifying their collaboration participant classification. These tags, labels, or metadata may be associated with the user profile and maintained for future collaborations as well, and this may be used as an additional factor in future collaboration classifications.

The participant collaboration classifications may be used to segment the participants into the various collaboration sub-groups. The participants in the different collaboration sub-groups may be presented different elements of the collaboration based on their corresponding level of participant proficiency with the topics and concepts of the collaboration. In this way, while all of the participants are involved in the overall collaboration and overall collaboration group, the various collaboration sub-groups may be presented with different elements, or different versions of the elements, of the collaboration, e.g., different ones, or versions of content, e.g., different levels of detail of information, being exchanged between the participants. Thus, the virtual environment of the collaboration group may be separately, automatically, and dynamically modified to correspond to the particular collaboration sub-groups present in the collaboration group such that different sub-groups of participants are presented a different virtual experience of the collaboration. In this way, the virtual environment experience of the various participants in the collaboration is aligned to the participant collaboration sub-groups.

The different collaboration sub-groups may be represented and shown differently in the collaboration virtual environment, e.g., the Metaverse collaboration environment, such that participants are able to differentiate the sub-groups and the participants in the various sub-groups. The different virtual experience of the collaboration by the different sub-groups may include the participants in a sub-group interacting with content, or versions of content, of the collaboration that is specific to the particular sub-group. For example, users with a basic understanding of a particular knowledge domain, such as Fluid Mechanics and Fluid Dynamics, are categorized into one group. They are presented with the definition of the concept written in text for them to read and disgust the information. Users with intermediate knowledge of Fluid Mechanics and Fluid Dynamics are presented with a flow chart that shows how Fluid Mechanics and Fluid Dynamics are related. Users with advanced knowledge of Fluid Mechanics and Fluid Dynamics are presented with a more complex diagram that illustrates these concepts.

That is, just as the participants may be tagged, labeled, or associated with metadata indicating a classification of the participant into one of the predefined participant classifications, items of content of the collaboration virtual environment may be likewise tagged, labeled, or associated with such metadata. Hence, different items of content of the collaboration virtual environment may be modified and/or presented to different participants based on the classifications. These items of content may include particular conversations between participants in the collaboration group, audio streams or channels associated with the different collaboration sub-groups, different versions of electronic documents, slides, images, or the like. In some cases, environmental elements, such as background colors, lighting effects, or even interface elements of the virtual environment user interface, may be automatically modified and adapted to customize these elements to the particular collaboration sub-group to which the participant is currently assigned.

For example, simplified content may be presented to participants of the first basic participant proficiency collaboration sub-group, while more detailed and technical content may be presented to participants of a second advanced participant proficiency collaboration sub-group. Thus, participants are able to view the segmented collaboration virtual environment with their classified collaboration sub-group and experience the collaboration in a manner commensurate and aligned with their level of participant proficiency with the topics and concepts of the collaboration.

While participants may be associated with particular collaboration sub-groups in accordance with the automated evaluation of the various factors and classification of the participant based on the evaluation, participants may be provided functionality in the virtual environment to migrate from one collaboration sub-group to another when desired. That is, a primary source of collaboration of the participants may be within their automatically determined and assigned collaboration sub-group, but collaboration may still occur across collaboration sub-groups and participants may migrate across such collaboration sub-groups. As participants migrate from one collaboration sub-group to another, the various items of content, virtual environment elements, audio streams/channels, views and the like, may be automatically modified to be commensurate with the current collaboration sub-group with which the user is associated. This migration from one collaboration sub-group to another may be a temporary association while the automatically assigned collaboration sub-group may be maintained as a primary association for the participant such that they may return to their automatically assigned collaboration sub-group and access the items, elements, streams/channels, views, and the like, of their automatically assigned collaboration sub-group.

In some instances, collaboration sub-groups may be merged when conditions indicate such a merger will be beneficial to the collaboration group as a whole. That is, the mechanisms of the illustrative embodiments may continuously monitor the collaboration sub-groups and determine if participants of more than one of the collaboration sub-groups are accessing similar content, asking similar questions, providing similar responses, and the like, to one another such that the differentiation between the collaboration sub-groups is such that the participants may obtain better collaboration by merging the collaboration sub-groups such that all participants of the multiple collaboration sub-groups that are merged may collaborate with each other. Such merger may be based on the progression of participant communications and interaction patterns and may be confirmed by participant input agreeing to the merger. The collaboration virtual environment content may then be updated based on the merged collaboration sub-groups.

Thus, in a collaborative virtual environment, e.g., Metaverse environment, such as an online training session, workplace presentation, learning session, or other collaborative virtual environment in which levels of participant proficiency with the topics and concepts of the collaboration is of importance, the illustrative embodiments may be employed to classify the metaverse participants based on their level of participant proficiency, interaction patterns, etc., such as the types of questions asked, types of interaction performed by the participant with other participants and with the virtual environment, types of responses provided by the participant to other participant questions or requests, etc. The illustrative embodiments dynamically segment the participants in the collaboration based on their level of participant proficiency with the topics/concepts, the user's specific requirements, the users preferences, and the like, e.g., who asks more question, who wants a slow rate of presentation, who performs offtrack discussion, etc. and allocates appropriately classified participants to different segmented collaboration sub-groups.

The user, or participant, can move from one classification sub-group to another classification sub-group in the collaboration virtual environment to adjust the content of the collaboration presented to them based on their level of participant proficiency and interaction. For example, if a user asks a question to the presenter, and other participants do not want to get the answer (e.g., they already know the answer), then the participating users will have the option to select if they want to listen to the answering of the question or want to move ahead. Accordingly, the virtual collaborative environment can create user-defined segmentation of the virtual collaboration environment content and assign the participating users to different segmented virtual collaboration environment contents.

The participating users of the collaboration virtual environment can visualize the different classified collaboration sub-groups and are presented with the associated segmented collaboration sub-group contents for the collaboration sub-group to which the participant is assigned. That is, the participating users will be able to view how many segmented virtual environment collaborations are present, e.g., how many different collaboration sub-groups are currently associated with the collaboration virtual environment and, and their respective status of virtual environment collaboration (e.g., still not able to understand a topic), and accordingly participants can move from one segmented virtual environment collaboration sub-group to another.

The content and/or versions of content presented to the participants associated with a collaboration sub-group will be tailored to the specific collaboration sub-group. This may involve having different versions of content for different levels of participant proficiency, which may be presented to the corresponding collaboration sub-groups, for example. Thus, there may be a document and that document may have three different versions, potentially with different content at different levels of detail or different topics/concepts, where the different versions may correspond to basic, intermediate, and advanced levels of participant proficiency with the overall topic(s)/concept(s) that are the focus of the overall collaboration. In some illustrative embodiments, the virtual collaborative environment may be segmented into the collaboration sub-groups and audio may be segmented across the collaboration sub-groups, such that participants in one sub-group may not necessarily be provided with the audio streams from other collaboration sub-groups.

In some cases, a participant's eye gaze may be monitored by virtual reality/augmented reality (VR/AR) equipment to determine the representations of collaboration sub-groups in the VR/AR environment on which the participants' attention falls. Corresponding collaboration sub-group content, e.g., audio streams, may be presented to the participant based on their eye gaze. In this way, the participant may dynamically hop from one collaboration sub-group to another and back again as the participant is, or is not, interested in or comfortable with the content presented to the participants of the different collaboration sub-groups.

Thus, the illustrative embodiments provide improved computing tools and improved computing tool operations/functionality specifically directed to solving the technological problems associated with virtual collaboration environments, and specifically to being able to automatically and dynamically adapt the virtual collaboration environment to the level of participant proficiency with the topics/concepts that are the focus of the collaboration as indicated by the virtual environment interaction by the various participants in the collaboration. These mechanisms operate to enhance the experience of the collaboration by the participants in the collaboration via the virtual collaboration environment so as to customize the virtual collaboration environment to the participants' level of participant proficiency.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a dynamic virtual collaboration environment segmentation engine. The improved computing tool implements mechanism and functionality, such as the dynamic segmentation of virtual collaboration environments based on participant levels of understanding/comfort/experiences (participant proficiency) as represented by the participants' interactions with the virtual collaboration environment, which cannot be practically performed by human beings either outside of, or with the assistance of, a technical environment, such as a mental process or the like. The improved computing tool provides a practical application of the methodology at least in that the improved computing tool is able to dynamically and automatically customize the virtual collaboration environment to the participants' exhibit level of participant proficiency through automated computer analysis and classification of participants.

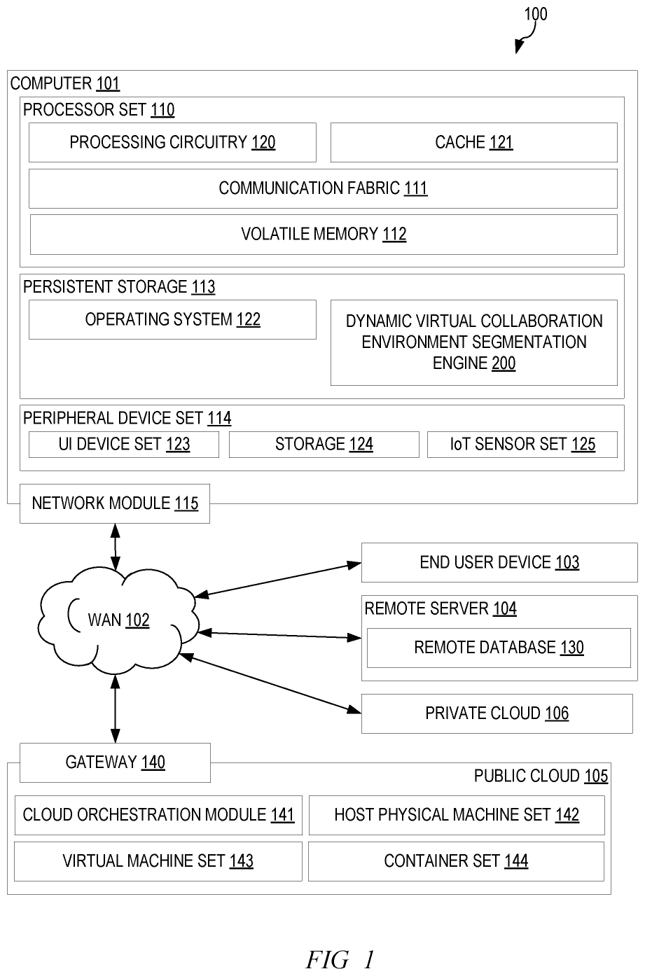

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as the dynamic virtual collaboration environment segmentation engine 200. In addition to dynamic virtual collaboration environment segmentation engine 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and dynamic virtual collaboration environment segmentation engine 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in dynamic virtual collaboration environment segmentation engine 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in dynamic virtual collaboration environment segmentation engine 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a dynamic virtual collaboration environment segmentation engine 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computing device (computer)101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates dynamic segmentation of virtual collaboration environments based on identification of collaboration sub-groups, which in turn are based on the exhibited level of participant proficiency of participants with the topics/concepts of the collaboration.

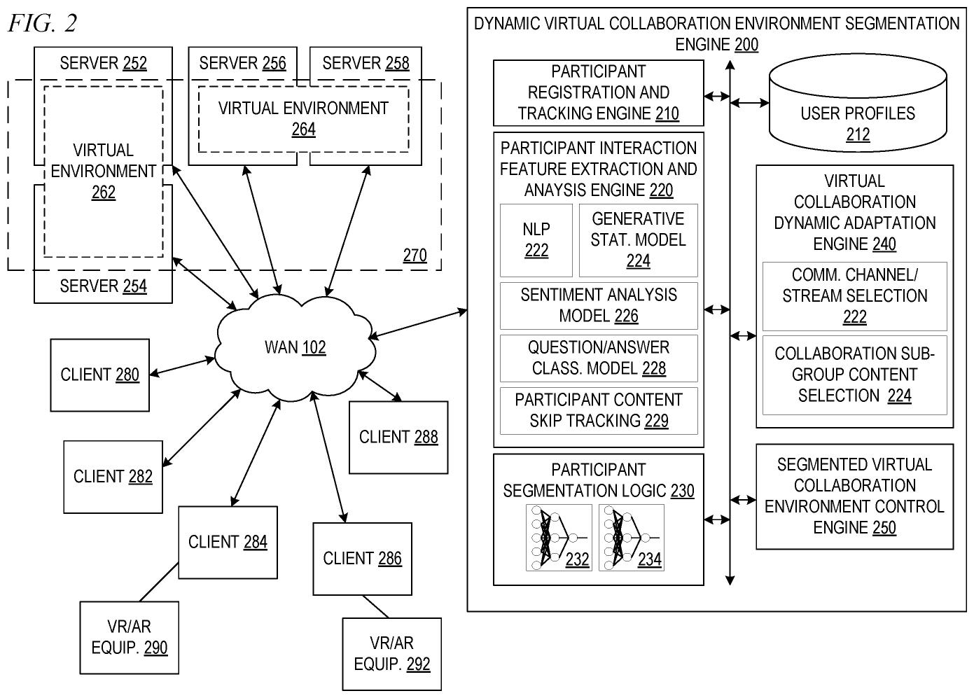

FIG. 2 is an example block diagram of the primary operational components of a dynamic virtual collaboration environment segmentation engine in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., inputs to the virtual collaboration environment, and the resulting output may aid human beings. The invention is specifically directed to the automatically operating computer components directed to dynamically segment a virtual collaboration environment based on an analysis of participant inputs to classify the participants into one of a plurality of collaboration sub-groups and customizing the presentation of content and interaction of participants to the particular collaboration sub-groups. The invention provides a specific solution to the problems of generalized virtual collaboration environments by providing automated improved computing tools and improved computing tool operations/functionality that cannot be practically performed by human beings as a mental process and is not directed to organizing any human activity.

As shown in FIG. 2, the dynamic virtual collaboration environment segmentation engine 200 includes a participant registration and tracking engine 210, participant interaction feature extraction and analysis engine 220, participant segmentation logic 230, virtual collaboration dynamic adaptation engine 240, and segmented virtual collaboration environment control engine 250. The participant interaction feature extraction engine 220 may further comprise natural language processing (NLP) logic 222, generative statistical model 224, sentiment analysis model 226, question/answer classification model 228, and participant content skip tracking logic 229. The participant segmentation logic 230 may comprise one or more trained machine learning computer models 232-234 for classifying participants into collaboration sub-groups based on the various features extracted by the participant interaction feature extraction and analysis engine 220 and the results of the analysis performed by the various elements 222-229 of the participant interaction feature extraction and analysis engine 220. The virtual collaboration dynamic adaptation engine 240 may comprise communication channel/stream selection logic 242, collaboration sub-group content selection logic 244, and the like. The segmented virtual collaboration environment control engine 250 comprises logic for controlling the presentation of virtual collaboration content to the various participants based on the segmentation and assignment of participants to collaboration sub-groups, as determine by the virtual collaboration dynamic adaptation engine 240.

The dynamic virtual collaboration environment segmentation engine 200 operates in conjunction with one or more computing devices 252-258 that provide one or more virtual environments 262-264 which may be combined into a virtual world 270, such as the Metaverse virtual world, for example. The one or more virtual environments 262-264 may include virtual collaboration environments, e.g., virtual representations of conference rooms, academic halls, workshops, offices, or simply rooms, for example. Various users of client computing devices 280-288 may collaborate with one another via the virtual collaboration environments using their client computing devices 280-288, potentially also using VR/AR equipment 290-292 which may include hardware/software for performing eye gaze detection, audio input capture, video/audio playback, and other hardware/software for presenting virtual/augmented environments and receiving various user inputs. Data transfer between computing devices is accomplished via one or more data networks.

For purposes of illustration, the dynamic virtual collaboration environment segmentation engine 200 is shown as a separate computing device from the one or more computing devices 252-258 providing the one or more virtual environments 262-264. However, the illustrative embodiments are not limited to such an architecture. To the contrary, in some illustrative embodiments the dynamic virtual collaboration environment segmentation engine 200 may be implemented with or integrated with the mechanisms of the one or more computing devices 252-258 for presenting the one or more virtual environments 262-264 and specifically the virtual collaboration environments of these one or more virtual environments 262-264. Although not shown in FIG. 2, the dynamic virtual collaboration environment segmentation engine 200 comprises sufficient interfaces, application programming interfaces (API), libraries, and the like, necessary to interface with the one or more virtual environments 262-264 and computer resources, applications, and the like, that are used to provide the one or more virtual environments 262-264.

Assuming that a virtual collaboration environment is generated in the one or more virtual environments 262-264, participants may utilize their client computing devices 252-258 and/or VR/AR equipment 290-292 to register and enter the virtual collaboration environment to enter into the collaboration. The participant registration and tracking engine 210 identifies the registered participants in the collaboration and retrieves corresponding user profiles for the registered participants from a user profile storage 212. The participant registration and tracking engine 210 tracks which virtual collaboration environments the user enters or which the user becomes a participant. The user profiles provide information specific to the user which may include previous assessments of the user's participant proficiency with various categories of collaboration topics/concepts, the user's location or cultural origin, and other factors that may be informative to evaluating which collaboration sub-groups the user may be properly assigned to enhance that user's experience as a participant in the collaboration.

For purposes of the following description, the operation of the elements shown in FIG. 2 will be described with regard to a single participant primarily, in order to illustrate the operation of the illustrative embodiments on a per-participant basis. However, it should be appreciated that these operations may be performed automatically and dynamically for each participant in the virtual collaboration environment at substantially a same time as participants interact with the virtual collaboration environment, are assigned to and move between collaboration sub-groups, and the like.

In a virtual collaborative environment within a virtual environment 262-264, the participant registration and tracking engine 210 tracks the number of participants (users) who have joined a collaboration. The participant interaction feature extraction and analysis engine 220 evaluates the progress of the collaboration through analysis of patterns of interactions and discourse between users, e.g., questions posed by users to one another as part of the collaboration, to thereby evaluate the level of participant proficiency (e.g., understanding, experience, comfort) of each of the users (participants) with regard to the subject matter topic(s), concepts, etc. of the collaboration. These patterns of interaction and discourse may include the participants' (users') reactions to changes in the collaborative virtual environment. These patterns may include, for example, other users' input to the collaborative virtual environment, and changes in the collaborative virtual environment based on such user inputs, as well as reactions to specific statements, questions, and the like, made by other participants in the collaboration. The evaluation of such patterns of interaction, discourse, and the like, may involve performing speech-to-text translation when the inputs are speech input, and may include natural language processing of textual representations of user inputs to identify various characteristics of the user inputs.

Thus, for example, a user (participant) input to the virtual collaboration environment may be tracked and features extracted that are indicative of the nature of the participant's interaction. For example, terms/phases from textual and/or audio speech input may be extracted and processed to determine the participant's level of understanding, comfort, and experience (participant proficiency) with the topics/concepts of the collaboration. This may involve performing NLP logic 222 on the textual and/or audio speech input to extract features from the text and/or text representations of audio speech via one or more audio channels of the virtual environment, i.e., the discourse between the participant and other participants, and evaluate those features as to what patterns of text are present in the participant's input and classify these patterns with regard to levels of participant proficiency with the topics/concepts. The NLP logic 222 may implement known or later developed natural language processing tools that analyze language and identify various natural language content characteristics including topics, concepts, and with regard to the mechanisms of the illustrative embodiments, terms/phrases indicative of levels of participant proficiency with the experience of the collaboration and the topics/concepts being discussed. The NLP logic 222 may operate in conjunction with the generative statistical model 224 that evaluates features extracted from the natural language representations of the user input to generate explanations of the patterns in the observed features, e.g., identifying similarities between observed patterns, e.g., patterns of topics, concepts, terms/phrases, and the like, identified in the participant's discourse. An example of a generative statistical model 224 that may operate on such participant discourse may be a Latent Dirichlet Allocation (LDA) model, but other generative statistical models may also be utilized.

The NLP logic 222 may also operate in conjunction with the sentiment analysis model 226 to evaluate the sentiment of the participant's discourse. The sentiment analysis model 226 may implement any known or later developed computer logic that identifies terms/phrases indicative of sentiments in natural language content and correlates these terms/phrases with particular sentiments towards a topic/concept that is the focus of the natural language content. The sentiment analysis model 226 may detect positive, negative, and neutral emotion to topics/concepts. In some cases, the sentiment analysis model 226 may further include image and gesture analysis logic that evaluates facial expressions and body language of the participant, e.g., via sensors of the VR/AR equipment, and/or participant's virtual avatar via the representations of the virtual avatar within the virtual collaboration environment. By correlating facial expressions, body language, gestures, and the like, with the topics/concepts of the discourse from the participant and/or other participants in the virtual collaboration environment, the mechanisms of the illustrative embodiments are able to identify an emotional factor that may be indicative of a level of participant proficiency with the topics/concepts, e.g., users are typically not happy, confused, or are frustrated by topics/concepts that they do not understand, are not comfortable with, or have little experience with.

The features extracted by the NLP logic 222 (e.g., an NLP engine), results of the generative statistical model 224, and the results of the sentiment analysis 226 may be provided to a question/answer classification model 228 along with questions submitted by and answered by the participant. The question/answer classification model 228 operates on these inputs to classify questions posed by the participant with regard to the various topics/concepts of the collaboration and the participant proficiency, e.g., the user asks questions about fluid dynamics and uses terms/phrases indicating a basic understanding of the topic/concept of fluid dynamics, and thus, this indicates that the user has a basic level of participant proficiency with the topic/concept of fluid dynamics. These operations can be applied to not only the questions asked by the participant as part of the textual chats, audio communications, or the like, occurring in the virtual collaboration environment between the participant and other participants, but also may be applied to answers provided by the participant to other participant questions.

In addition, the participant content skip tracking logic 229 may monitor participant interactions within the virtual collaboration environment with regard to the participant using a “skip” function or user interface element to skip an interaction between another participant and the collaboration group. That is, another participant may ask a question or initiate a topic/concept discussion that the current participant does not wish to engage in or wish to discuss. As a result, the current participant may select a “skip” function or user interface element to avoid the discussion. The participant content skip tracking logic 229 detects that participant input and correlates it with the topic/concept of the discussion being skipped. This may be used as additional evaluation factors when evaluating the assignment of the participant to a collaboration sub-group, as participants tend to skip discussions of topics/concepts that they already have an understanding of and are comfortable with, i.e., have a higher participant proficiency.

Thus, via the participant interaction feature extraction engine 220, various features are extracted and evaluated by the elements 222-229 to generate features indicative of a participant's proficiency with the topics/concepts of the collaboration being conducted in the participants current virtual collaboration environment. These features may include natural language terms/phrases extracted from natural language content that the participant provides or responds to, gestures, facial expressions, and body language of the participant and/or the participant's virtual avatar, sentiment of the participant's communications or interactions with other participants in the virtual collaboration environment, types of questions posed/answered by the participant, and discussions skipped by the participant. These are only examples of the types of collaboration interaction features that may be extracted by the participant interaction feature extraction engine 220 which may then serve as a basis for participant segmentation of the virtual collaboration environment. Those of ordinary skill in the art, in view of the present description, will recognize other interaction features that may be used in addition to, or in replacement of, one or more of these interaction features without departing from the spirit and scope of the present invention.

The interaction features extracted by the participant interaction feature extraction engine 220 are input to the participant segmentation logic 230 which comprises one or more trained machine learning computer models 232-234. These trained machine learning computer models 232-234 are trained to process the interaction features, or a selected subset of the interaction features, as input and generate predictions/classifications based on those interaction feature inputs. Each machine learning computer model 232-234 may be trained to perform such predictions/classifications with regard to a different aspect of the interaction feature inputs.

For example, one machine learning model 232 may process the interaction features corresponding to natural language processing based features, sentiment analysis features, and question/answer classification features, while another machine learning model 234 may process the interaction features corresponding to the facial expressions, gestures, and body language of the participant/avatar. As another example, the machine learning computer models 232-234 may evaluate the interaction features to generate other types of classifications of the participant other than participant proficiency. For example, some machine learning computer models may be used to evaluate whether the participant is “active” or “not active” in responding to questions by other participants. Some machine learning models may be used to evaluate whether or not the participant provides answers to other participant questions that are valid or accurate answers, e.g., based on participant responses to the participant's answers. Some machine learning models may evaluate whether or not the participant asks questions that are pertinent to the topics/concepts being discussed. These classifications of the participant may be input to other machine learning models as inputs to evaluate the participant proficiency, for example. Thus, the machine learning models 232-234 may evaluate the participants to generate predictions/classifications of various aspects of participant proficiency.

Some of the machine learning computer models 232-234 generate an output indicating a prediction/classification of participant proficiency based on the processing of their respective input interaction features, e.g., a classification into one or more predefined classifications, a scoring of the participant proficiency on a predefined scale (e.g., 0 to 100), or the like. The predictions/classifications of the machine learning computer models 232-234 may be combined by prediction/classification aggregation logic to generate a final prediction/classification of the participant proficiency. This may involve a majority vote type aggregation, an averaging type aggregation, or any other suitable aggregation of the outputs from the various machine learning models to generate a final determination of participant proficiency.

It should be appreciated that while two machine learning computer models 232-234 are shown in FIG. 2, it should be appreciated that the illustrative embodiments are not limited to two machine learning computer models 232-234. To the contrary, any number of machine learning computer models, less than or greater than the depicted two, may be used without departing from the spirit and scope of the illustrative embodiments, and may be trained to process any one or more of the interaction features as input to generate corresponding predictions/classifications.

Based on the participant proficiency prediction/classification for a participant, the participant segmentation logic 230 assigns the participant to a collaboration sub-group, e.g., basic proficiency sub-group, intermediate proficient sub-group, advanced proficiency sub-group, or the like. This assignment of the participant to a collaboration sub-group may then be communicated to the virtual collaboration dynamic adaptation engine 240 which adapts the virtual collaboration environment perceived by the participant, via their client computing device or other computer interface into the virtual collaboration environment, so as to present content, discourse, and interactions commensurate with their assigned collaboration sub-group. The segmented virtual collaboration environment control engine 250 may receive inputs from the virtual collaboration dynamic adaptation engine 240 and send control communications to the virtual collaboration environment providers to control the presentation of the virtual collaboration environment, such as by setting up separate collaboration sub-groups and corresponding sub-environments within the virtual collaboration environment, e.g., side rooms or sections of the virtual collaboration environment, such that each collaboration sub-group may be provided it's on separate portion of the virtual collaboration environment. These controls may further specify what communication channels and types of content are to be provided to the different collaboration sub-groups in their associated sub-environments.

For example, the collaboration sub-group content selection logic 244 provides content, or versions of content, that are associated with the collaboration sub-group to the participants assigned to the collaboration sub-group while other content, or versions of content, for other collaboration sub-groups are not provided to those participants. Similarly, the participant collaboration, such as via text and audio channels, may be limited to discourse between the participants assigned to the same collaboration sub-group in some illustrative embodiments. In other words, the audio channel/stream selection logic 242 may perform communication routing and presentation such that participants in the same collaboration sub-group are provided communications and may send communications to other participants in the same collaboration sub-group and avoid communications from other participants outside the collaboration sub-group if desired. The content presented to participants in each of the separate collaboration sub-groups is tailored to the particular collaboration sub-group, e.g., simplified content rendered for a basic proficiency collaboration sub-group and a more complex content for participants in an advance proficiency collaboration sub-group. In short, the content and interactions between participants in the collaboration environment are aligned with the assignment of participants to collaboration sub-groups such that separate representations of the virtual collaboration environment are presented to participants in different collaboration sub-groups.

It should be appreciated, as previously noted above, that while participants may be assigned to collaboration sub-groups based on the automated prediction/classification of the participant's proficiency with the topics/concepts of the collaboration, the participants may still be presented with representations of the other collaboration sub-groups and may change collaboration sub-groups as desired by the participant via their user interface and/or VR/AR interface. That is, if a participant in a first collaboration sub-group wants to engage in collaboration with other collaboration sub-groups, the participant may freely “move” between collaboration sub-groups as desired, while maintaining metadata or tags specifying the automatically identified classification/prediction of participant proficiency and original collaboration sub-group assignment. This metadata or tags may be used as an additional factor when performing subsequent automated classification/predictions of participant proficiency, such as by factoring an affinity to a previous classification/prediction.

In some illustrative embodiments, the different collaboration sub-groups may be presented to participants in a different manner in the virtual collaboration environment, e.g., with different colors, graphical content, or the like, and the individual participants associated with each of the different collaboration sub-groups may likewise be represented differently with different color or fonts associated with their avatar names, different halos around their avatars, or any other way of conspicuously identifying which participants are associated with which collaboration sub-groups.

If, at some point, it is determined that collaboration sub-groups should be merged, such merger may be performed by the segmented virtual collaboration environment control engine 250. For example, if participants have migrated out of a collaboration sub-group, and there are no participants, or less than a predetermined threshold of participants, currently in the collaboration sub-group, then that collaboration sub-group may be merged into another collaboration sub-group such that common contents and communication channels may be presented to the merged collaboration sub-group. Such merger can also be instigated at the request of the participants, e.g., a majority of the participants in both collaboration sub-groups agree to the merger.

Thus, the illustrative embodiments provide improved computing tools and improved computing tool operations/functionality to automatically and dynamically modify and adapt virtual collaboration environments to the determined participant proficiencies with regard to the topics/concepts of the collaboration. The illustrative embodiments provide improved computer functionality to customize virtual collaboration environments to the exhibit proficiency of the participants to thereby improve the collaboration experience for the participants by providing different collaboration sub-groups and corresponding content, communication channels, and collaboration sub-environments.

For example, in some illustrative embodiments the system can collect the user's text input when they interact through the virtual collaboration environment. The illustrative embodiments can also collect the user's audio input and use speech to text technology to generate text output. The illustrative embodiments associate the user IDs with their inputs so the system can retrieve which user provided what information. The illustrative embodiments categorize the users based on analyzing their communication to determine if they have a basic, intermediate, and advanced understanding of the topics, for example. The analysis can leverage bag of words and Word2Vec techniques to identify the patterns of user's understanding in the context. The illustrative embodiments can leverage Convolutional Neural Networks (CNNs) to analyze the images that contain people's facial expressions and body language, and the CNN can generate image classification, object detection, and semantic segmentation using these images. The illustrative embodiments associate the user IDs with these images so that the illustrative embodiments can successfully correlate which user had what facial expression or body language. The illustrative embodiments determine if the user has a basic or intermediate, or advanced understanding of the topics. The illustrative embodiments correlate the analysis results with the categorization based on the user's text input. The illustrative embodiments divide the users based on the final categorization results.

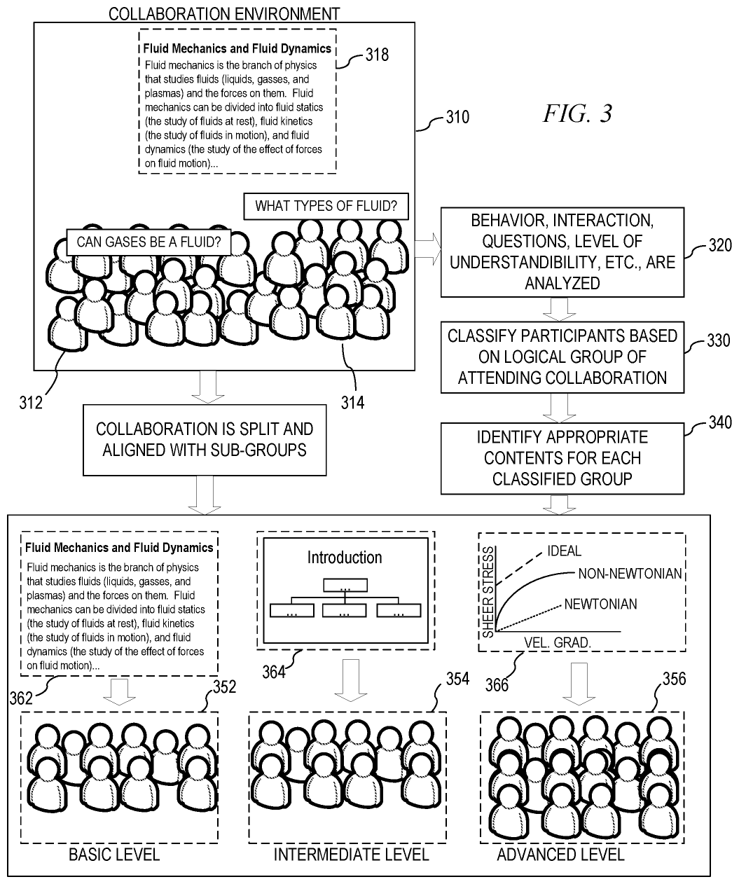

FIG. 3 is an example diagram illustrating the dynamic segmentation of a virtual collaboration environment 300 in accordance with one illustrative embodiment. As shown in FIG. 3, an initial collaboration group 310 is established which has a large number of participants 312-314 and collaboration group content 318 that is presented to the participants 312. As a result of viewing, hearing, or otherwise engaging with the collaboration group content 318, different participants 312 will have different questions and proficiencies with the topics/concepts of the content 318 being presented. For example, one or more first participants 312 may ask questions about gases and fluids while one or more second participants 314 may ask other questions, such as questions about types of fluids.

The mechanisms of the illustrative embodiments may analyze the behavior, interaction, questions, and the other interactions of the participants 312-314 in the virtual collaboration environment 300 to determine, for each participant their level of participant proficiency with the topics/content of the collaboration group content 318 (320). Based on the determined levels of participant proficiency, the participants are classified into different collaboration sub-groups (330). Based on the associations of participants with collaboration sub-groups 352-356 different contents 362-366 are provided to each collaboration sub-group in accordance with the participant proficiency of the participants in that collaboration sub-group (340). Thus, a modified virtual collaboration environment 350 is generated having multiple collaboration sub-groups 352-356, with potentially different sub-environments, e.g., break-out rooms or the like, with each collaboration sub-group 352-356 being presented with different contents 362-366 corresponding to the participant proficiencies and having separate discourse channels.

While the participants are assigned to different collaboration sub-groups 352-356 automatically by the mechanisms of the illustrative embodiments, the participants may be free to move between the collaboration sub-groups 352-356 as desired. In some cases, if a collaboration sub-group is to be merged with other collaboration sub-group(s) such merger can be performed and thus, the collaboration sub-groups may be dynamically created, merged, or removed based on the determined requirements of the participants of the collaboration.

Moreover, the evaluation of the participant proficiency may be performed periodically or continuously and if a participant's proficiency is determined to be different from the previously determined level of participant proficiency, a notification may be displayed to the participant asking if they wish to transition to a different collaboration sub-group corresponding to their most current determined level of participant proficiency. This may be an increased level of proficiency or a decreased level of proficiency. If the participant agrees to the change, the participant may be reassigned to a different collaboration sub-group and automatically start receiving content and communication/discourse channel data corresponding to their newly assigned collaboration sub-group.

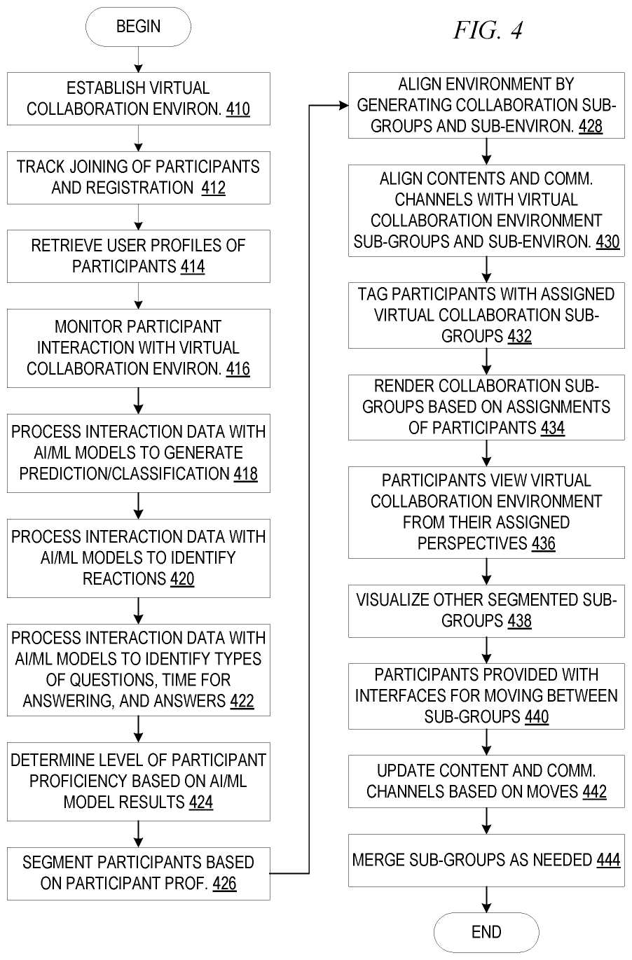

FIG. 4 is a flowchart outlining an example operation for dynamically segmenting a virtual collaboration environment in accordance with one illustrative embodiment. It should be appreciated that the operations outlined in FIG. 4 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 4, and may, in some cases, make use of the results generated as a consequence of the operations set forth in FIG. 4, the operations in FIG. 4 themselves are specifically performed by the improved computing tool in an automated manner.

As shown in FIG. 4, the operation starts with the establishment of a virtual collaboration environment for a collaboration (step 410). In establishing the virtual collaboration environment, indicators of the primary topics/concepts that are the focus of the collaboration may be specified in the configuration of the virtual collaboration environment and/or contents to be presented during the collaboration may be specified which may have associated metadata, tags, or the like, that indicate the topics/concepts present in the content to be presented. This information provides an indicator of topics/concepts for use in correlating participant proficiencies with the content that is being presented as part of the collaboration.

Participants then join the virtual collaboration environment through a registration process and the registration of the participants with the virtual collaboration environment is tracked (step 412). The user profiles for the registered participants are retrieved (step 414) and the user profile information will be used as additional factors for evaluating participant proficiency, e.g., any previous metadata or tags indicating a level of proficiency of the participant with particular topics/concepts may be retrieved and used as additional factors for automatically identifying the participant proficiency during the current collaboration.

The virtual collaboration environment is monitored with regard to each participant's interaction with other participants and with content of the virtual collaboration environment to thereby identify patterns of interactions by the various participants indicative of participant proficiency (step 416). The illustrative embodiments can access the content rendered in the metaverse environment. The illustrative embodiments keep track of the collaboration artifacts among different participants, where the artifacts can be in different text, image, audio, video, and gestures.

The illustrative embodiments may use various artificial intelligence and machine learning computer models to process the collected data and identify the patterns therein along with corresponding predictions/classifications (step 418). For example, the illustrative embodiments may apply Natural Language Processing (NLP) techniques to classify the data and determines the patterns in terms/phrases and other utterances by the participants in both questions asked and answers provided to other participant questions during the collaboration. The illustrative embodiments can use topic modeling techniques such as Latent Dirichlet Allocation (LDA) to determine the questions asked. Latent Dirichlet Allocation is a generative statistical model that allows observations to be explained by unobserved groups, which explains why some parts of the data are similar. It assumes that any document is a combination of topics and phrases.

The illustrative embodiments may use various artificial intelligence and machine learning computer models to process the collected data and identify participant reactions in the virtual collaboration environment (step 420). For example, the illustrative embodiments may implement machine learning computer models that perform sentiment analysis on the participant's communication by detecting positive, negative, or neutral emotions in text/audio to denote understanding, experience, or comfort with topics/concepts as well as other sentiments, such as urgency or the like. As another example, facial expression and body language analysis may be used with the participant and/or participant's avatar to determine whether the participant is experiencing confusion, discomfort, a lack of patience, or the like, with the particular topics/concepts being discussed or presented during the collaboration.

The illustrative embodiments may also use various artificial intelligence and machine learning computer models to process the collected data and identify the types of questions asked by the participant, the time required for answering the question, and the particular answers that the other participants provide to the questions (step 422). The natural language processing and sentiment analysis may be applied to these questions and the results of such natural language processing and sentiment analysis may be associated with the types of the questions so as to indicate factors indicative of the level of participant proficiency with the topics/concepts associated with that type of question.

Based on the various factors gathered through the artificial intelligence and machine learning model analysis of the collected collaboration data, the illustrative embodiments determine, for each participant, their level of participant proficiency (step 424). A machine learning model may be trained on appropriate training data indicating various input factors and a ground truth of the participant's proficiency and, through a plurality of epochs of machine learning, e.g., linear regression or the like, the model learns associations between patterns of the input factors and the participant proficiency such that it can predict/classify other participants based on their corresponding input factors.

The illustrative embodiments segment the participants based on their corresponding automatically determined level of participant proficiency (step 426). Again, the determination of the participant proficiency and thus, the segmentation of the participants may be based on artificial intelligence and machine learning model evaluation of the answers the participants provided, the accuracy of the answers, the interaction patterns among participants, determinations of whether the participants are active or not active in responding to particular types of questions, questions asked by the participants, and the like. An additional factor may include identifying types of questions that a particular participant does not answer or actively chooses to skip.

Having identified segmentations of participants, the virtual collaboration environment is then aligned with the different segmentations of participants by providing different collaboration sub-groups and corresponding virtual collaboration sub-environments (step 428). The contents and communication channels associated with the different virtual collaboration environment sub-groups and sub-environments (step 430) such that the differently classified participants are presented with content and communication channels commensurate with their determined participant proficiency. In some illustrative embodiments, the participants are tagged or otherwise associated with metadata indicating their assigned virtual collaboration sub-groups (step 432). The illustrative embodiments render the collaboration sub-groups based on the assignment of the participants in accordance with the segmentation (step 434).

The participants are able to view the virtual collaboration environment from the perspective of their assigned segmented virtual collaboration sub-group (step 436). The participants are also able to visualize or otherwise see the other segmented virtual collaboration group sub-groups as visually different from their own sub-group, e.g., color, font, accentuation, demarcation in the virtual environment, or the like (step 438). The participant is provided with interface elements to allow the user to navigate between segmented virtual collaboration environment sub-group and change assignment to different sub-groups (step 440) and the content and communication channels for that participant will then be updated for the new sub-group association (step 442). The sub-groups are monitored and merging of the sub-groups is performed in response to merge criteria being satisfied, e.g., less than a predetermined number of assigned participants, concept/topic discussions mirroring each other between sub-groups, participant requests for merger, and the like, (step 444).

A determination is made as to whether the virtual collaboration environment is discontinued (step 446). If not, the operation returns to step 410. Otherwise, if the virtual collaboration environment is discontinued, the operation terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for segmenting a virtual collaboration environment of a virtual collaboration based on participant proficiency with collaboration topics of the virtual collaboration, the method comprising:
collecting, from a first participant of the virtual collaboration environment, interaction data corresponding to at least one of communications exchanged by the first participant with one or more second participants in the virtual collaboration environment, actions performed by the first participant or an avatar of the first participant, or reactions performed by the first participant or the avatar in response to interactions by the one or more second participants;
classifying the first participant with regard to a level of participant proficiency with collaboration topics of the virtual collaboration environment based on the interaction data;
segmenting the virtual collaboration environment into a plurality of collaboration sub-groups and assigning participants to the plurality of collaboration sub-groups based on determined levels of participant proficiency of the first participant and the one or more second participants; and
aligning content provided to the participants of the virtual collaboration and communication channels between the participants of the virtual collaboration based on the assignment of participants to a collaboration sub-group in the plurality of collaboration sub-groups.

2. The method of claim 1, wherein classifying the first participant comprises evaluating question types of questions in the interaction data and determining the level of participant proficiency based on the question types.

3. The method of claim 1, wherein classifying the first participant comprises evaluating a time required for the first participant to answer questions posed by the one or more second participants and a type of answer provided by the first participant to questions posed by the one or more second participants.

4. The method of claim 1, wherein classifying the first participant further comprises retrieving a user profile of the first participant and analyzing user profile characteristics in combination with the interaction data to determine the level of participant proficiency for the first participant.

5. The method of claim 1, wherein the interaction data comprises at least one of textual communications input by the first participant to the virtual collaboration environment, speech input by the first participant to the virtual collaboration environment, and images of the first participant or the avatar of the first participant that show facial expressions or body language.

6. The method of claim 5, wherein classifying the first participant with regard to the level of participant proficiency comprises evaluating each of a plurality of different factors extracted from the textual communications, the speech input, or the images, by different corresponding machine learning models and combining results of each of the different corresponding machine learning models to generate a classification of the first participant level of participant proficiency, wherein the different corresponding machine learning models comprise a natural language processing machine learning model, a sentiment analysis machine learning model, and an image analysis machine learning model.

7. The method of claim 1, wherein the plurality of collaboration sub-groups comprise a first collaboration sub-group associated with participants having a basic level of participant proficiency with the collaboration topics, a second collaboration sub-group associated with participants having an intermediate level of participant proficiency with the collaboration topics, and a third collaboration sub-group associated with participants having an advanced level of participant proficiency with the collaboration topics.

8. The method of claim 7, wherein aligning content provided to the participants of the virtual collaboration and communication channels between the participants of the virtual collaboration based on the assignment of participants to collaboration sub-groups in the plurality of collaboration sub-groups comprises providing different collaboration content of the virtual collaboration environment to participants in the first collaboration sub-group than to the second and third collaboration sub-groups.

9. The method of claim 8, wherein the different collaboration content comprises different versions of collaboration content provided to participants in the second and third collaboration sub-group.

10. The method of claim 7, wherein aligning content provided to the participants of the virtual collaboration and communication channels between the participants of the virtual collaboration based on the assignment of participants to collaboration sub-groups comprises routing communication channels of participants in the same collaboration sub-group to other participants in the same collaboration sub-group while blocking communication channels of participants from other collaboration sub-groups.

11. A computer program product comprising a computer readable storage medium having a computer readable program stored therein, wherein the computer readable program, when executed on a data processing system, causes the data processing system to segment a virtual collaboration environment of a virtual collaboration based on participant proficiency with collaboration topics of the virtual collaboration, at least by:
collecting, from a first participant of the virtual collaboration environment, interaction data corresponding to at least one of communications exchanged by the first participant with one or more second participants in the virtual collaboration environment, actions performed by the first participant or the avatar of the first participant, or reactions performed by the first participant or avatar in response to interactions by the one or more second participants;
classifying the first participant with regard to a level of participant proficiency with collaboration topics of the virtual collaboration environment based on the interaction data;
segmenting the virtual collaboration environment into a plurality of collaboration sub-groups and assigning participants to the plurality of collaboration sub-groups based on determined levels of participant proficiency of the first participant and the one or more second participants; and
aligning content provided to the participants of the virtual collaboration and communication channels between the participants of the virtual collaboration based on the assignment of participants to a collaboration sub-group in the plurality of collaboration sub-groups.

12. The computer program product of claim 11, wherein classifying the first participant comprises evaluating question types of questions in the interaction data and determining the level of participant proficiency based on the question types.

13. The computer program product of claim 11, wherein classifying the first participant comprises evaluating a time required for the first participant to answer questions posed by the one or more second participants and a type of answer provided by the first participant to questions posed by the one or more second participants.

14. The computer program product of claim 11, wherein classifying the first participant further comprises retrieving a user profile of the first participant and analyzing user profile characteristics in combination with the interaction data to determine the level of participant proficiency for the first participant.

15. The computer program product of claim 11, wherein the interaction data comprises at least one of textual communications input by the first participant to the virtual collaboration environment, speech input by the first participant to the virtual collaboration environment, and images of the first participant or the avatar of the first participant that show facial expressions or body language.

16. The computer program product of claim 15, wherein classifying the first participant with regard to the level of participant proficiency comprises evaluating each of a plurality of different factors extracted from the textual communications, the speech input, or the images, by different corresponding machine learning models and combining results of each of the different corresponding machine learning models to generate a classification of the first participant level of participant proficiency, wherein the different corresponding machine learning models comprise a natural language processing machine learning model, a sentiment analysis machine learning model, and an image analysis machine learning model.

17. The computer program product of claim 11, wherein the plurality of collaboration sub-groups comprise a first collaboration sub-group associated with participants having a basic level of participant proficiency with the collaboration topics, a second collaboration sub-group associated with participants having an intermediate level of participant proficiency with the collaboration topics, and a third collaboration sub-group associated with participants having an advanced level of participant proficiency with the collaboration topics.

18. The computer program product of claim 17, wherein aligning content provided to the participants of the virtual collaboration and communication channels between the participants of the virtual collaboration based on the assignment of participants to collaboration sub-groups in the plurality of collaboration sub-groups comprises providing different collaboration content of the virtual collaboration environment to participants in the first collaboration sub-group than to the second and third collaboration sub-groups.

19. The computer program product of claim 18, wherein the different collaboration content comprises different versions of collaboration content provided to participants in the second and third collaboration sub-group.

20. An apparatus comprising:
at least one processor; and
at least one memory coupled to the at least one processor, wherein the at least one memory comprises instructions which, when executed by the at least one processor, cause the at least one processor to segment a virtual collaboration environment of a virtual collaboration based on participant proficiency with collaboration topics of the virtual collaboration, at least by:
collecting, from a first participant of the virtual collaboration environment, interaction data corresponding to at least one of communications exchanged by the first participant with one or more second participants in the virtual collaboration environment, actions performed by the first participant or an avatar of the first participant, or reactions performed by the first participant or avatar in response to interactions by the one or more second participants;
classifying the first participant with regard to a level of participant proficiency with collaboration topics of the virtual collaboration environment based on the interaction data;
segmenting the virtual collaboration environment into a plurality of collaboration sub-groups and assigning participants to the plurality of collaboration sub-groups based on determined levels of participant proficiency of the first participant and the one or more second participants; and
aligning content provided to the participants of the virtual collaboration and communication channels between the participants of the virtual collaboration based on the assignment of participants to collaboration sub-groups in the plurality of collaboration sub-groups.
